(19) United States
(12) Patent Application Publication
(10) Pub. No.: US 2017/0124880 A1
(43) Pub. Date: May 4, 2017

(54) APPARATUS FOR RECOGNIZING VEHICLE LOCATION

(71) Applicant: DENSO CORPORATION, Kariya-city (JP)

(72) Inventors: Koujirou Tateishi, Nishio-city (JP); Naoki Kawasaki, Nishio-city (JP); Shunsuke Suzuki, Kariya-city (JP); Hiroshi Mizuno, Kariya-city (JP)

(21) Appl. No.: 15/288,413

(22) Filed: Oct. 7, 2016

(30) Foreign Application Priority Data
Oct. 9, 2015 (JP) 2015-201235

(51) Int. Cl. G08G 1/16; B60W 30/12; G05D 1/02

(52) U.S. Cl. CPC G08G 1/167; G05D 1/0219; G05D 1/0234; B60W 30/12; G05D 2201/0213; B60W 2550/22; B60W 2710/20

(57) ABSTRACT

In an apparatus for recognizing a location of an own vehicle, a detector is configured to detect one or more own-vehicle location candidates on roads based on map data. A partition line determiner is configured to, based on a captured image of a road around the own vehicle, determine a line type of each of partition lines extending along edges of the road. A determiner is configured to, for each of the one or more own-vehicle location candidates, under assumption that the own vehicle is at the own-vehicle location candidate, if the own vehicle is passing an intersection, determine, based on the line type of each of partition lines, a degree of confidence indicative of a likelihood that the own-vehicle location candidate at which it is assumed that the own vehicle is present is a location of the own vehicle.

### CROSS-REFERENCE TO RELATED APPLICATION

This application is based on and claims the benefit of priority from earlier Japanese Patent Application No. 2015-201235 filed Oct. 9, 2015, the description of which is incorporated herein by reference.

### BACKGROUND

Technical Field

The present invention relates to a technique for recognizing a location of a vehicle.

Related Art

A navigation apparatus disclosed in Japanese Patent Application Laid-Open Publication No. 2015-68665 is configured to extract, from a captured image, characteristics of a road that the own vehicle is traveling on (hereinafter referred as road characteristics), such as the number of lanes or lane widths of the lanes of the road, and based on a correlation value between the extracted road characteristics and road characteristics data pre-stored in a storage device, determine a road associated with the road characteristics data most correlated with the extracted road characteristics, and calculate a location of the own vehicle on the determined road.

However, there may be a situation where a plurality of roads having similar road characteristics exist around the own vehicle. In such a situation, the above technique is unable to accurately recognize the road that the own vehicle is traveling on, which may prevent the location of the own vehicle from being accurately calculated.

In consideration of the foregoing, exemplary embodiments of the present invention are directed to providing a technique for accurately recognizing a location of an own vehicle.

### SUMMARY

In accordance with a first exemplary embodiment of the present invention, there is provided an apparatus for recognizing a location of an own vehicle. The own vehicle is a vehicle carrying the apparatus. The apparatus includes a detector configured to, based on map data, one or more own-vehicle location candidates on roads, each of the one or more own-vehicle location candidates being likely to be a location of the own vehicle; a pass determiner configured to, for each of the one or more own-vehicle location candidates, under assumption that the own vehicle is at the own-vehicle location candidate, determine whether or not the own vehicle is passing an intersection that stands for either or both of a point where a first road and a second road merging with the first road intersect and a point where a first road and a second road diverging from the first road intersect, the first road being referred to as an intersected road, the second road being referred to as an intersecting road; a partition line determiner configured to, based on a captured image of a road around the own vehicle, determine a line type of each of partition lines extending along edges of the road; and a determiner configured to, if it is determined by the pass determiner that the own vehicle is passing the intersection, determine, based on the line type of each of partition lines, a degree of confidence indicative of a likelihood that the own-vehicle location candidate at which it is assumed that the own vehicle is present is a location of the own vehicle.

Partition lines extending along right and left road edges are provided. Such partition lines are herein referred to as road outer lines. At a point where a second road interests with a first road, a portion of the road outer line of the first road, located on the border between the first road and the second road, may be a broken line or a null line. Also, at a point where a second road diverges from a first road, a portion of the road outer line of the first road, located on the border between the first road and the second road, may be a broken line or a null line.

As above, for each of the one or more own-vehicle location candidates, under assumption that the own vehicle is at the own-vehicle location candidate, it is determined whether or not the own vehicle is passing an intersection. In addition, based on an image of a road captured during the own vehicle passing the intersection, a line type of a portion of the road outer line, located on the border between the first road and the second road, is determined. Based on the determined line type, a degree of confidence indicative of a likelihood that own-vehicle location candidate at which it is assumed that the own vehicle is present is a location of the own vehicle is determined or calculated. One of the plurality of vehicle location candidates is determined as a location of the own vehicle based on the degree of confidence, which allows the location of the own vehicle to be accurately determined.

### BRIEF DESCRIPTION OF THE DRAWINGS

FIG. 1A is a block diagram of a vehicle-mounted system in accordance with a first embodiment of the present invention;

FIG. 1B is a functional block diagram of a controller of a navigation unit of the vehicle-mounted system shown in FIG. 1A;

FIG. 1C is a functional block diagram of a controller of a white-line recognition unit of the vehicle-mounted system shown in FIG. 1A;

FIG. 2 is an example of road surface image where a road diverges from another road;

FIG. 3 is a flowchart of own-vehicle location recognition processing of the first embodiment;

FIG. 4 is an example of an extraction image in accordance with a second embodiment of the present invention; and

FIG. 5 is an example of a non-extraction image of the second embodiment.

### DESCRIPTION OF SPECIFIC EMBODIMENTS

Embodiments of the present invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### 1. First Embodiment

1-1. System Configuration

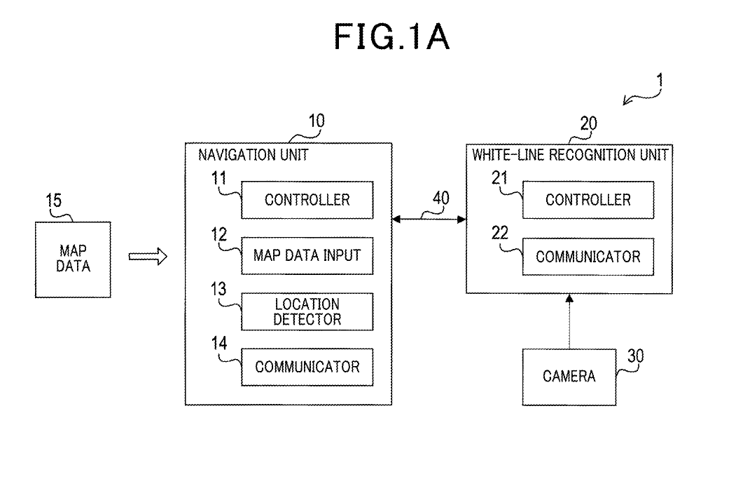

A vehicle-mounted system 1 shown in FIG. 1A, which is an apparatus for recognizing a location of a vehicle carrying the system 1 (hereinafter referred to as an own vehicle), includes a navigation unit 10, a white-line recognition unit 20, a camera 30. The navigation device 10 and the white-line recognition unit 20 are communicable with each other via an in-vehicle LAN (e.g., a controller area network (CAN)) 40.

The navigation unit 10 is configured to recognize a location of the own vehicle used for driver assistance, such as Lane Keeping Assist for assisting a driver of the own vehicle in steering so that the own vehicle travels in a lane, or automatic driving that allows the own vehicle to automatically travel to a destination. The navigation unit 10 includes a controller 11, a map data input 12, a location detector 13, and a communicator 14.

The controller 11 may be configured as a microcomputer including a central processing unit (CPU), a read-only memory (ROM), a random-access memory (RAM), an input-output interface, and other components. Various functions of the controller 11 to control various elements of the navigation unit 10 may be implemented by the CPU executing computer programs stored in the ROM or loaded to the RAM, or may be realized not only in software, but also in hardware, for example, in logic circuitry, analog circuitry, or combinations thereof.

The map data input 12 is configured to receive various data, such as map data 15, stored in a storage media, such as a digital video disc (DVD) or a hard-disc drive (HDD). The map data 15 is used for driver assistance or other purposes. The map data 15 includes links representing a shape of a road and location information of nodes, where each of the links connects a pair of nodes at ends of the link. The links connected to each other form a road network. The map data 15 includes information indicative of a type of each road formed by a plurality of links, a width of each road, the number of lanes of each road. The map data 15 includes feature information about buildings and terrains.

The location detector 13 includes at least a global positioning system (GPS) receiver, a gyro sensor, an acceleration sensor. The GPS receiver is configured to receive signals from GPS satellites via GPS antennas (not shown), and based on the received signals, detect at least a location, a travel direction, and a travel speed of the own vehicle. The gyro sensor is configured to detect the magnitude of rotational movement of the own vehicle. The acceleration sensor is configured to detect a front-to-rear acceleration of the own vehicle. Based on detection results of the GPS receiver and these sensors, the location detector 13 recognizes a location of the own vehicle on the map indicated by the map data 16 as the location of the own vehicle.

The communicator 14 is configured to communicate with other units mounted in the own vehicle via the in-vehicle LAN 40. The camera 30 is configured to capture images of a front view and an around view of the own vehicle every predetermined time interval and output a video signal of each captured image to the white-line recognition unit 20.

The white-line recognition unit 20 is configured to, based on the video signal from the camera 30, generate an image of a road surface around the own vehicle captured every predetermined time interval (herein after referred to as a road surface image), and based on the generated road surface image, recognize partition lines drawn on the road. The white-line recognition unit 20 may be configured to recognize partition lines of various colors including not only a white color, but also an orange color or other colors. The white-line recognition unit 20 includes at least a controller 21 and a communicator 22.

The controller 21 of the white-line recognition unit 20 may be configured as a microcomputer including a central processing unit (CPU), a read-only memory (ROM), a random-access memory (RAM), an input-output interface, and other components. Various functions of the controller 21 to control various elements of the white-line recognition unit 20 may be implemented by the CPU executing computer programs stored in the ROM or loaded to the RAM, or may be realized not only in software, but also in hardware, for example, in logic circuitry, analog circuitry, or combinations thereof.

The communicator 22 is configured to communicate with other units mounted in the own vehicle via the in-vehicle LAN 40.

1-2. Processing

The vehicle-mounted system 1 is configured to, based on a type of a road outer line at an intersection, recognize a location of the own vehicle.

The road outer line is a partition line extending along a right or left road edge to separate a roadside or shoulder from lanes of a road. An intersection stands for either or both of a point where a first road and a second road merging with the first road intersect and a point where a first road and a second road diverging from the first road intersect. Such two intersecting roads (i.e., the first and second roads) are in parallel with each other around the intersection. More specifically, examples of the intersection may include a point where a main road, such as a superhighway or an elevated highway, and a minor road diverging from the main road intersect, and a point where a main road and a minor road merging onto the main road intersect. It will be understood that, as used herein, the terms “first” and “second” are merely used to denote two different roads.

In the followings, in a case where a first road merges with a second road at an intersection, the first and second roads are respectively referred to as an intersecting road and an intersected road. In a case where a first road diverges from a second road at an intersection, the first and second roads are respectively referred to as an intersecting road and an intersected road.

The road outer lines extending along left and right road edges of an intersected road are also provided at an intersection of the intersecting and intersected roads. That is, at an intersection of intersecting and intersected roads, the road outer line of the intersected road is provided on the border between the intersected road and the intersecting road.

As described above, the navigation unit 10 is configured to, based on the signals received from the GPS satellites via the location detector 13, detect a location of the own vehicle. However, the accuracy of the location of the own vehicle detected only from the signals received from the GPS satellites is low. Thus, the navigation unit 10 is configured to correct such a location of the own vehicle via map-matching or the like. That is, the navigation unit 10 is configured to, based on a shape of each road determined from the map data 15 and a travel trajectory of the own vehicle, estimate a point on a road as the location of the own vehicle.

Even though the location of the own-vehicle is corrected in such a way, there may be a situation where not a single point, but each of a plurality of points on the road can be estimated as a location of the own-vehicle. Such a plurality of points are hereinafter referred to as own-vehicle location candidates. Such a situation may occur, particularly, when the own vehicle is traveling in an area where a plurality of roads having similar shapes and extending in the same direction are in proximity to each other. Examples of such an area may include an area where a main road and a minor road are in parallel with each other, and an area where a road on the ground is provided along an elevated highway.

The following two cases may occur at an intersection on an intersected road:
case (1) where a portion of the road outer line of the intersected road, located on the border between the intersected road and the intersecting road, is a broken line; and

case (2) where a portion of the road outer line of the intersected road, located on the border between the intersected road and the intersecting road, is a null line. That is, in case (2), the road outer line of the intersected road is broken on the border between the intersected road and the intersecting road.

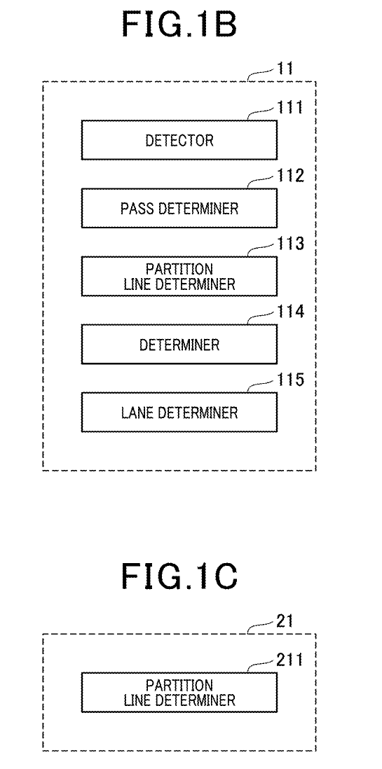

Referring to FIG. 2, a road surface image 100 illustrates an intersection where a main road 110 and a minor road 120 diverging from the main road 110 intersect. The main road 110 is an intersected road, and the minor road 120 is an intersecting road. A portion of the road outer line of the main road 110, located on the border between the main road 110 and the minor road 120, is a broken line. A lane of the intersected road, closest to the intersecting road at the intersection, is referred to as an intersected lane. At the intersection, the intersected lane is just adjacent to the intersecting road with the road outer line of the intersected road between the intersected lane and the intersecting road. In the road surface image 100, a portion 130 of the road outer line of the main road, between the intersected lane 111 and the minor road 120, is a broken line.

The navigation unit 10 is configured to, when an own-vehicle location candidate has reached an intersection of an intersected road and an intersecting road, determine a degree of confidence of the own-vehicle location candidate based on a line type of a portion of the road outer line of the intersected road, located on the border between the intersected road and the intersecting road, where the line type is determined by the white-line recognition unit 20. The degree of confidence of the own-vehicle location candidate is a parameter which increases with increasing likelihood that the own-vehicle location candidate is a location of the own-vehicle. That is, in the case (1) or (2), based on the determined line type of the road outer line, the own vehicle is deemed to be passing the intersection. Then, the degree of confidence of the own-vehicle location candidate that has reached the intersection is increased. The navigation unit 10 is configured to consider the own-vehicle location candidate having the highest degree of confidence as being the location of the own-vehicle, and based on the location of the own-vehicle, perform the driver assistance or the like.

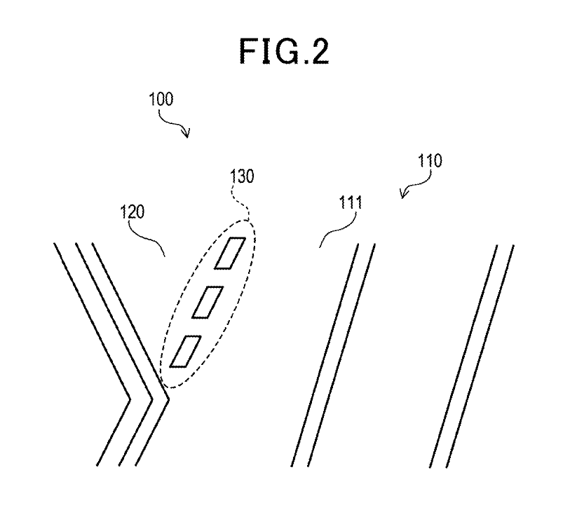

Own-vehicle location recognition processing will now be described with reference to FIG. 3. This processing is performed by the white-line recognition unit 20 and the navigation unit 10. This processing is performed when the operation of the navigation unit 10 is started.

In step S200, the controller 11 of the navigation unit 10 detects one or more own-vehicle location candidates based on a detection result from the location detector 13. More specifically, the controller 11 of the navigation unit 10 detects one or more own-vehicle location candidates based on the signals from the GPS satellites and via map-matching.

In step S205, the controller 21 of the white-line recognition unit 20 extracts edge points from the road surface image captured every predetermined time interval. Each edge point is a pixel having a large difference in value of a color parameter (e.g., luminance value) with respect to its adjacent pixels. That is, each edge point is a pixel having a difference in value of a color parameter greater than a predetermined threshold with respect to its adjacent pixels. The controller 21 horizontally scans the road surface image to extract edge points, for example, via the Canny edge detection algorithm or differential edge detection techniques.

In step S210, the controller 21 extracts partition line candidates based on the edge points, and for each of the partition line candidates, calculates a likelihood that is a degree of confidence that the partition line candidate is a partition line. The likelihood for each of the partition line candidates may be calculated based on a contrast between the partition line candidate and its surrounding region, features of a road around the partition line candidate, a pattern and an average luminance value of the partition line candidate, an amount of edge points of the partition line candidate or others. The controller 21 considers the partition line candidates having a likelihood equal to or greater than a predetermined threshold as partition lines.

In step S215, the controller 21 determines a road outer line from the partition lines based on the road surface image, and determine a line type of the road outer line located around the own vehicle. That is, the controller 21 determines whether the road outer line is a broken line or a solid line, and determine whether or not the road outer line is broken.

More specifically, the road outer line extends in the travel direction of the own vehicle. Therefore, in the road surface image, the road outer line extends in an up-down direction. Edge points used to detect a road outer line may be extracted by horizontally scanning the road surface image. Thus, the number of edge points at the periphery of the solid line is greater than the number of edge points at the periphery of the broken line.

The controller 21 is provided with thresholds A, B where A>B. If A>X where X is a density of edge points at the periphery of a road outer line (hereinafter referred to as an edge point density of a road outer line), the road outer line may be considered a solid line. If A≧X>B, the road outer line may be considered a broken line. If the edge density decreased from X>A to X≦B, the road outer line may be considered as being missing.

Edge points may be extracted by vertically scanning the road surface image. In such a case, the number of edge points at the periphery of a solid road outer line is less than the number of edge points at the periphery of a broken road outer line. Therefore, if X>A where X is the edge point density of a road outer line, the road outer line may be considered a broken line. If A≧X>B, the road outer line may be considered a solid line. If the edge density decreases from X>B to X≦B, the road outer line may be considered as being missing.

Alternatively, the controller 21 may determine a type of the road outer line by comparing the number of edge points of each road outer line instead of the edge point density. In step S220, the controller 11 of the navigation unit 10 determines, for each of the own-vehicle location candidates, a road that the own-vehicle location candidate is on. Such a road that an own-vehicle location candidate is on may be referred to as a candidate road. A plurality of the own-vehicle location candidates may be located on one candidate road. For each of the own-vehicle location candidates, under assumption that the own vehicle lies at the own-vehicle location candidate, the controller 11 determines, based on the map data 15, a segment of the candidate road in which the own vehicle is expected to travel during a predetermined time period. Such a segment is hereinafter referred to as a travel segment.

In step S225, the controller 11 determines, for each travel segment, whether or not there is an intersection in the travel segment based on the nodes and links included in the map data 15. If in step S225 it is determined that there is at least one travel segment including an intersection, the controller 11 determines that the own vehicle is passing the intersection. Thereafter, the process flow proceeds to step S230. Then, based on the map data 15, the controller 11 defines a border between an intersected road and an intersecting road at the intersection. If in step S225 it is determined that there is no travel segment including an intersection, the controller 11 deems that the own vehicle is not passing an intersection. Thereafter, the process flow proceeds to step S200.

In step S230 the controller 11 determines whether or not the own vehicle is traveling in the intersected lane. More specifically, the controller 11 may determine, based on a behavior of the own vehicle, whether or not the own vehicle is traveling in the intersected lane. That is, the controller 11 may determine a travel trajectory of the own vehicle based on a yaw rate, a steering angle, a travel speed and others of the own vehicle. The yaw rate of the like may be detected by a gyro sensor or an acceleration sensor included in the location detector 13. The yaw rate or the like may be acquired from other units via the in-vehicle LAN 40. The controller 11 may determine whether or not the own vehicle is traveling in the intersected lane based on the travel trajectory and a location of the intersected lane determined from the map data 15.

Alternatively, for example, the controller 11 may be determine the lane that the own vehicle is traveling in by means of the radar or the camera, and based on the lane that the own vehicle is traveling in and a location of the intersected lane determined from the map data 15, determine whether or not the own vehicle is traveling in the intersected lane. Still alternatively, for example, the controller 11 may determine whether or not the own vehicle is traveling in the intersected lane via matching between planimetric features detected by a radar, a camera or the like and feature information included in the map data 15.

Still alternatively, for example, the controller 21 of the white-line recognition unit 20 may determine, based on a position of the road outer line in the road surface image, determine whether or not the own vehicle is traveling in the intersected lane. The controller 11 of the navigation unit 10 may receive a determination result from the white-line recognition unit 20.

If in step S230 it is determined that the own vehicle is traveling in the intersected lane, then the process flow proceeds to step S235. In cases where the own vehicle is traveling on a two-way road having a single lane for each direction, the controller 11 may immediately determine that the own vehicle is traveling in the intersected lane. Thereafter, the process flow may proceed to step S235. If in step S230 it is determined that the own vehicle is not traveling in the intersected lane, then the process flow proceeds to step S200.

In step S235, the controller 11 determines a line type of a portion of the road outer line of the intersected road that the own vehicle is traveling on, located on the border between the intersected road and the intersecting road. More specifically, the controller 11 acquires, from the white-line recognition unit 20, information indicative of a line type of a portion of the road outer line of the intersected road that the own vehicle is traveling on, located on the border between the intersected road and the intersecting road. If in step S235 the acquired information indicates that a line type of a portion of the road outer line of the intersected road that the own vehicle is traveling on, located on the border between the intersected road and the intersecting road is a solid line, then the process flow proceeds to step S240. If in step S235 the acquired information indicates that a line type of a portion of the road outer line of the intersected road that the own vehicle is traveling on, located on the border between the intersected road and the intersecting road is a broken line or a null line, then the process flow proceeds to step S245.

In step S240, the controller 11 degreases the degree of confidence of the own-vehicle location candidate at which it has been assumed that the own vehicle is present to determine the travel segment including the intersection. In step S245, the controller 11 increases the degree of confidence of the own-vehicle location candidate at which it has been assumed that the own vehicle is present to determine the travel segment including the intersection.

In step S250, the controller 11 determines the own-vehicle location candidate having the highest degree of confidence as a location of the own vehicle. Thereafter the process flow proceeds to step S200. As above, the degree of confidence of the own-vehicle location candidate is set in step S240 or S245. a way to set the degree of confidence of the own-vehicle location candidate is not limited to that of step S240 or S245.

As shown in FIG. 1B, the controller 11 of the navigation unit 10 includes, as functional blocks, a detector 111 responsible for execution of step S200, a pass determiner 112 responsible for execution of step S225, a lane determiner 115 responsible for execution of step S230, a partition line determiner 113 responsible for execution of step S235, and a determiner 114 responsible for execution of steps S240, S245. as shown in FIG. 1C, the controller 21 of the white-line recognition unit 20 includes, as functional blocks, a partition line determiner 211 responsible for execution of steps S205-S215. the partition line determiner 113 of the white-line recognition unit and the partition line determiner 211 of the white-line recognition unit 20 forms partition line determiner of the own-vehicle location recognition unit. These blocks correspond to the respective functions of the controllers 11, 21 can be realized not only in software, but also in hardware, for example, in logic circuitry, analog circuitry, or combinations thereof.

1-3. Advantages

The first embodiment described as above in detail can provide the following advantages.

(1) In the own-vehicle location recognition processing, for each of the own-vehicle location candidates, under assumption that the own vehicle is at the own-vehicle location candidate, it is determined whether or not the own vehicle is passing an intersection of an intersected road and an intersecting road. If it is determined that the own vehicle is passing an intersection, then based on the road surface image in which the intersection appears, a line type of a portion of the road outer line of the intersected road, located on the border between the intersected road and the intersecting road, is determined. If the portion of the road outer line of the intersected road, located on the border between the intersected road and the intersecting road, is a solid line, a degree of confidence of the own-vehicle location candidate is decreased. If the portion of the road outer line of the intersected road, located on the border between the intersected road and the intersecting road, is a broken line or a null line, the degree of confidence of the own-vehicle location candidate is increased. Thereafter, the own-vehicle location candidate having the highest degree of confidence is determined as a location of the own-vehicle.

This configuration allows a likelihood that the own-vehicle location candidate is a location of the own-vehicle to be accurately determined.

(2) In the own-vehicle location recognition processing, a line type of a portion of the road outer line of the intersected road, located on the border between the intersected road and the intersecting road is determined based on the edge point density or the number of edge points in the road surface image.

(3) In the own-vehicle location recognition processing, if the own vehicle is passing an intersection of an intersected road and an intersecting road and if the own vehicle is traveling in the intersected lane of the intersected road, a degree of confidence of the own-vehicle location candidate is determined based on a line type of a portion of the road outer line of the intersected road, located on the border between the intersected road and the intersecting road. This configuration allows the degree of confidence of the own-vehicle location candidate to be determined accurately when a portion of the road outer line of the intersected road, located on the border between the intersected road and the intersecting road, appears in the road surface image.

(4) In the own-vehicle location recognition processing, at an intersection of an intersected road and an intersecting road, a line type of a portion of the road outer line of the intersected road, located on the border between the intersected road and the intersecting road, is determined. This configuration allows a degree of confidence of the own-vehicle location candidate to be accurately determined.

### 2. Second Embodiment

2-1. Differences from First Embodiment

A second embodiment will now be described. The essential configuration of the second embodiment is similar to that of the first embodiment. Therefore, only differences of the second embodiment from the first embodiment will be described and no description about the common configuration between the first and second embodiments is not provided in order to avoid repetitions. Elements having the same functions as those in the first embodiment are assigned the same numbers.

The own-vehicle location recognition processing of the second embodiment is similar to, but different in step S215 from the own-vehicle location recognition processing of the first embodiment. In step S215 of the own-vehicle location recognition processing of the first embodiment, the controller 21 of the white-line recognition unit 20 determines a line type of the road outer line based on the number of edge points. In step S215 of the own-vehicle location recognition processing of the second embodiment, the controller 21 of the white-line recognition unit 20 determines a line type of the road outer line as follows.

It is thought that edge points are extracted on a periodic basis from a fixed detection area in road surface images captured sequentially during traveling of the own vehicle along a road outer line that is a broken line.

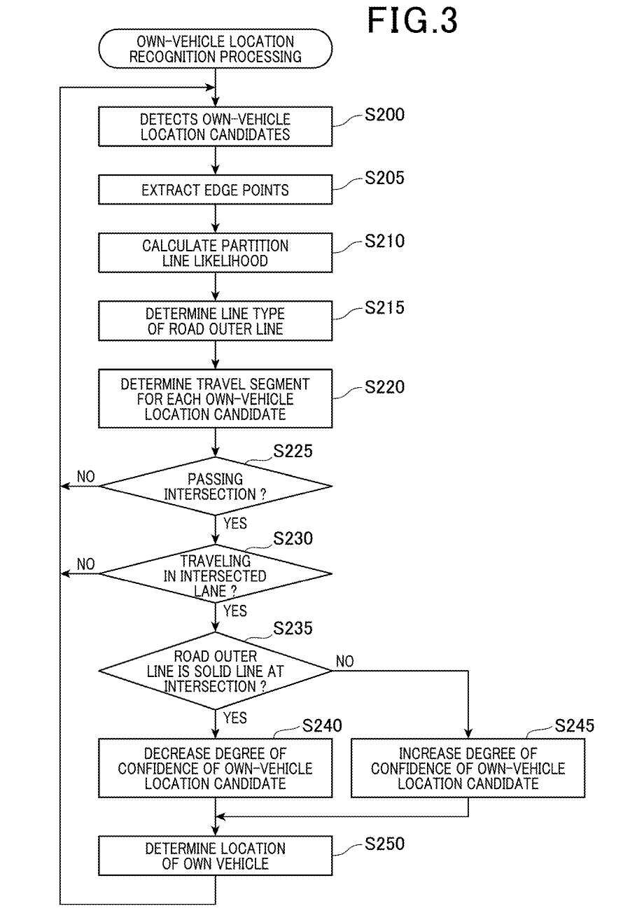

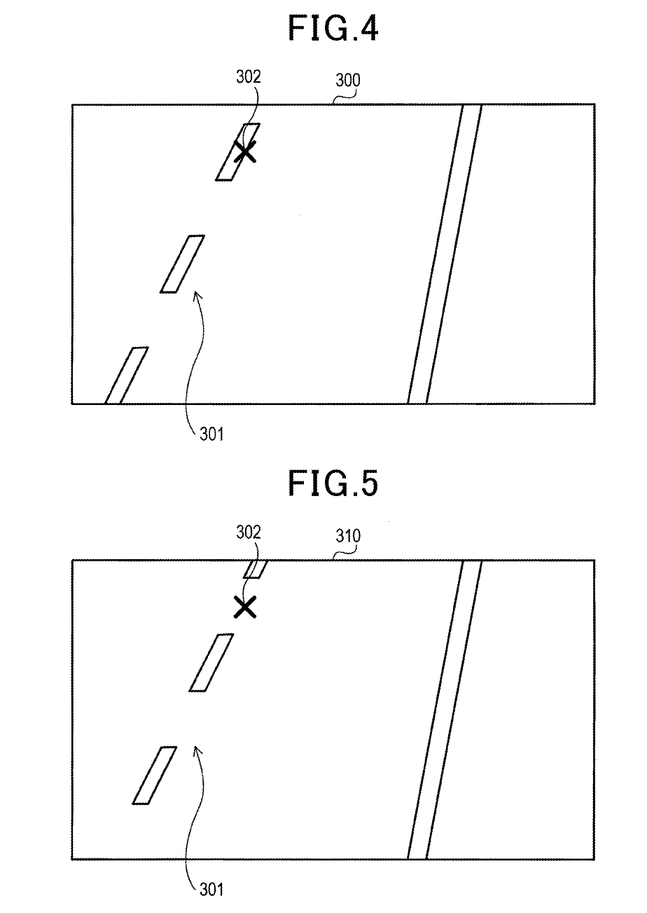

More specifically, FIG. 4 illustrates an extraction image 300 that is a road surface image of the detection area 302 from which edge points are extracted. FIG. 5 illustrates a non-extraction image 310 that is a road surface image of the detection area 302 from which no edge points are extracted. When the own vehicle travels along a road outer line that is a broken line, times when the extraction image 300 is captured alternate periodically in time with times when the non-extraction image 310 is captured.

In addition, it is thought that edge points are always extracted from a fixed detection area in each of the road surface images captured sequentially during traveling of the own vehicle along a road outer line that is a solid line. On the contrary, it is expected that no edge points are extracted from the fixed detection area of the road surface images captured sequentially while the own vehicle is traveling along a broken portion of the road outer line.

In the present embodiment, in step S215, the controller 21 of the white-line recognition unit 20 determines whether or not edge points are extracted from a fixed detection area in each of the road surface images captured sequentially during traveling of the own vehicle, and based on the determination result, determines, for each of the road surface images captured sequentially during traveling of the own vehicle, whether the road surface image is an extraction image or a non-extraction image. Further, the controller 21 determines whether or not times when the extraction image 300 is captured alternate periodically in time with times when the non-extraction image 310 is captured. If it is determined that times when the extraction image 300 is captured alternate periodically in time with times when the non-extraction image 310 is captured, the controller 21 determines the road outer line as a broken line. If the extraction images 300 are more frequently captured than the non-extraction images 310, the controller 21 determines the road outer line as a solid line. If the non-extraction images 310 are sequentially captured for a predetermined time period captured after the extraction images 300 are sequentially captured, the controller 21 determines the road outer line as being missing.

The detection area is not limited in size. However, for a large detection area, a road surface image such that the number of edge points extracted from the large detection area exceeds a predetermined threshold may be determined to be an extraction image, and a road surface image such that the number of edge points extracted from the large detection area does not exceed the predetermined threshold may be determined to be a non-extraction image.

In each of the extraction image 300 and the non-extraction image 310, the detection area 302 is provided on the left hand side from the perspective of the drawing figure. Alternatively, the number of the detection areas may be more than one, and the detection area 302 may be provided at another position in the road surface image. For example, the detection area 302 may be provided on the right hand side, or may be provided at a position in the road surface image corresponding a view farthest from the own vehicle.

Still alternatively, the controller 21 may be configured to detect a road outer line from the road surface image, and based on a position of the road outer line in the road surface image, determine an area in which the road outer line is expected to exist. The controller 21 may be configured to set the detection area in this area.

2-2. Advantages

The second embodiment can provide the following advantages in addition to the advantages of the first embodiment (1), (3), and (4).

In the own-vehicle location recognition processing of the present embodiment, based on the detection result about edge points in a fixed detection area of each of the sequentially captured road surface images, a line type of the road outer line is determined. This configuration allows the road outer line to be accurately determined while suppressing a processing load.

### 3. Modifications

It is to be understood that the invention is not to be limited to the specific embodiments disclosed above and that modifications and other embodiments are intended to be included within the scope of the appended claims.

(1) In each of the first and second embodiments, the vehicle-mounted system 1 is configured such that the navigation unit 10 and the white-line recognition unit 20 are separate from each other. Alternatively, the vehicle-mounted system 1 may be configured such that the navigation unit 10 and the white-line recognition unit 20 are integrated with each other, thus forming a single unit.

The functions of a single component in each of the first and second embodiments may be distributed to a plurality of components, or the functions of a plurality of components may be integrated into a single component. At least part of the configuration of the above embodiments may be removed. At least part of the configuration of one of the above embodiments may be replaced with or added to the configuration of another one of the above embodiments. While only certain features of the invention have been illustrated, and described herein, many modifications and changes will occur to those skilled in the art. It is, therefore, to be understood that the appended claims are intended to cover all such modifications and changes as falling within the true spirit of the invention.

(2) It should be appreciated that the present invention is not to be limited to the vehicle-mounted systems disclosed above and that the present invention can be implemented in numerous ways, including a program for enabling a computer to function as any one of the vehicle-mounted systems disclosed above, a non-transitory computer readable storage medium, such as a semiconductor memory, storing such a program, and a method corresponding to the vehicle location recognition processing disclosed above.

What is claimed is:

1. An apparatus for recognizing a location of an own vehicle, the own vehicle being a vehicle carrying the apparatus, the apparatus comprising:
a detector configured to, based on map data, one or more own-vehicle location candidates on roads, each of the one or more own-vehicle location candidates being likely to be a location of the own vehicle;
a pass determiner configured to, for each of the one or more own-vehicle location candidates, under assumption that the own vehicle is at the own-vehicle location candidate, determine whether or not the own vehicle is passing an intersection that stands for either or both of a point where a first road and a second road merging with the first road intersect and a point where a first road and a second road diverging from the first road intersect, the first road being referred to as an intersected road, the second road being referred to as an intersecting road;
a partition line determiner configured to, based on a captured image of a road around the own vehicle, determine a line type of each of partition lines extending along edges of the road; and
a determiner configured to, if it is determined by the pass determiner that the own vehicle is passing the intersection, determine, based on the line type of each of partition lines, a degree of confidence indicative of a likelihood that the own-vehicle location candidate at which it is assumed that the own vehicle is present is a location of the own vehicle.

2. The apparatus according to claim 1, wherein the partition line determiner is configured to extract edge points from the captured image, and based on a number of extracted edge points, determine a type of each partition line, each of the edge points being a pixel having a difference in value of a color parameter greater than a predetermined threshold with respect to other pixels adjacent to the pixel.

3. The apparatus according to claim 1, wherein the partition line determiner is configured to extract edge points from a detection area of each of sequentially captured images of the road around the own vehicle, and based on changes in edge point extraction result, determine a line type of each partition line, each of the edge points being a pixel having a difference in value of a color parameter greater than a predetermined threshold with respect to other pixels adjacent to the pixel.

4. The apparatus according to claim 1, further comprising a lane determiner configured to determine whether or not a lane that the own vehicle is traveling in is an intersected lane that is a lane of the intersected road, the intersected lane being adjacent to the intersecting road at the intersection,
wherein the determiner is configured to, if it is determined by the pass determiner that the own vehicle is passing the intersection and if it is determined by the lane determiner that the own vehicle is traveling in the intersected lane, determine the degree of confidence.

5. The apparatus according to claim 1, wherein the pass determiner is further configured to, based on the map data, determine a portion of the partition line of the intersected road, located on a border between the intersected road and the intersecting road at the intersection, and
the determiner is configured to, based on a line type of the portion of the partition line of the intersected road, located on the border between the intersected road and the intersecting road at the intersection, determine the degree of confidence.
